(19) United States
(12) Patent Application Publication
(10) Pub. No.: US 2008/0074725 A1
(43) Pub. Date: Mar. 27, 2008

(54) MICRO DEVICES HAVING ANTI-STICTION MATERIALS

(75) Inventor: Shaoher X. Pan, San Jose, CA (US)

Correspondence Address: FISH & RICHARDSON P.C., PO BOX 1022, MINNEAPOLIS, MN, 55440-1022, US

(73) Assignee: SPATIAL PHOTONICS, INC., Sunnyvale, CA (US)

(21) Appl. No.: 11/467,507

(22) Filed: Aug. 25, 2006

(51) Int. Cl. G02B 26/00

(52) U.S. Cl. 359/291

(57) ABSTRACT

A method for fabricating a micro structure includes forming a first structure portion on a substrate; disposing a sacrificial material over the first structure portion; depositing a layer of a first structural material over the sacrificial material and the substrate; removing at least a portion of the sacrificial material to form a second structure portion in the layer of the first structural material, and forming a carbon layer on a surface of the second structure portion or on a surface of the first structure portion to prevent stiction between the second structure portion and the first structure portion. The second structure portion is connected with the substrate and is movable between a first position in which the second structural portion is separated from the first structure portion and a second position in which the second structure portion is in contact with the first structure portion.

### BACKGROUND

The present disclosure relates to the fabrication of micro structures and micro devices.

Micro devices often include components that can contact each other during operation. For example, a micro mirror built on a substrate can include a tiltable mirror plate that can be tilted by electrostatic forces. The mirror plate can tilt to an “on” position, where the micro mirror plate directs incident light to a display device, and to an “off” position, where the micro mirror plate directs incident light away from the display device. The mirror plate can be stopped by mechanical stops at the “on” or the “off” positions so that the orientation of the mirror plate can be precisely defined at these two positions. For the micro mirror to properly function, the mirror plate must be able to promptly change between the “on” or the “off” positions without any delay. For example, the mirror plate in contact with a mechanical stop in an “on” position must be able to separate from the mechanical stop instantaneously when an appropriate electrostatic force is applied to the mirror plate to tilt it toward the “off” position.

### SUMMARY

In one general aspect, the present invention relates to a method of fabricating a micro structure. The method includes forming a first structure portion on a substrate; disposing a sacrificial material over the first structure portion; depositing a layer of a first structural material over the sacrificial material and the substrate; removing at least a portion of the sacrificial material to form a second structural portion in the layer of the first structural material, wherein the second structural portion is connected with the substrate and is movable between a first position in which the second structural portion is separated from the first structure portion and a second position in which the second structure portion is in contact with the first structure portion; and forming a carbon layer on at least one of a surface of the second structure portion and a surface of the first structure portion to prevent stiction between the second structure portion and the first structure portion.

In another general aspect, the present invention relates to a method of fabricating a tiltable micro mirror plate. The method includes forming a post on a substrate; forming a projection on the substrate; disposing a sacrificial material over the substrate; depositing one or more layers of structural materials over the sacrificial material; removing at least a portion of the sacrificial material to form the tiltable micro mirror plate in connection with the post, wherein the tiltable micro mirror plate is movable between a first position in which the tiltable micro mirror plate is separated from the first structure portion and a second position in which the tiltable micro mirror plate is in contact with the projection on the substrate; and forming a carbon layer on at least one of a surface of the micro mirror plate and a surface of the projection on the substrate to prevent stiction between the micro mirror plate and the projection on the substrate.

In another general aspect, the present invention relates to a micro structure including a landing stop on a substrate; a post on the substrate; a mirror plate in connection with the post, wherein the mirror plate is movable between a first position in which the mirror plate is separated from the landing stop and a second position in which the mirror plate is in contact with the landing stop; and a carbon layer on a surface of the mirror plate or on a surface of the landing stop to prevent stiction between the micro mirror plate and the landing stop on the substrate.

In another general aspect, the present invention relates to a micro device including: a first stationary component having a first surface; a second moveable component having a second surface, wherein the second component is configured to move to cause the second surface to contact the first surface; and a carbon layer on at least one of the first surface and the second surface to prevent stiction between the first component and the second component.

Implementations of the system may include one or more of the following. The step of forming a carbon layer can include depositing carbon by CVD on the surface of the second structure portion or on the surface of the first structure portion. The carbon layer can be thicker than 0.3 nanometer. The carbon layer can be thicker than 1.0 nanometer. The sacrificial material can include amorphous carbon. The carbon layer can include amorphous carbon not removed in the step of removing a portion of the sacrificial material. The step of disposing the sacrificial material can include depositing carbon over the first structure portion by CVD or PECVD. The method can further include planarizing the sacrificial material prior to depositing the layer of the first structural material over the sacrificial material. The method can further include forming a mask over the layer of the first structural material; selectively removing the first structural material not covered by the mask to form an opening in the layer of the first structural material; and applying an etchant through the opening to remove the sacrificial material. At least part of the second structure portion can be electrically conductive. The second structure portion can be configured to move between the first position and the second position in response to one or more voltage signals applied to an electrode on the substrate or the electrically conductive part of the second structure portion. A lower surface of the second structure portion can be configured to contact an upper surface of the first structure portion in the second position and the carbon layer is formed on the lower surface of the second structure portion or the upper surface of the first structure portion. At least one of the first structure portion and the second structure portion can include a material selected from the group consisting of titanium, tantalum, tungsten, molybdenum, an alloy, aluminum, aluminum-silicon alloys, silicon, amorphous silicon, polysilicon, silicide and a combination thereof. The second structure portion can include a tiltable mirror plate and a post that supports the tiltable mirror plate.

Implementations may include one or more of the following advantages. The disclosed methods and systems may be useful for providing anti-stiction materials on contact areas that are hidden in a micro device. For example, the contact surfaces between a tiltable mirror plate and a landing stop on a substrate can be hidden underneath the mirror plate. The contact surfaces are often formed at the final stage of the device fabrication. The disclosed methods and system allow the anti-stiction material to be applied to the contact surfaces as part of the fabrication process. The disclosed methods and system allow the anti-stiction material to be isotropically deposited on the contact surfaces hidden under the mirror plate.

The present specification discloses that amorphous carbon can be deposited and removed as a sacrificial material by standard semiconductor processes. Amorphous carbon can be deposited by chemical vapor deposition (CVD) or plasma enhanced chemical vapor deposition (PECVD). Amorphous carbon can be removed by a dry process, such as isotropic plasma etching, microwave, or activated gas vapor. The removal is highly selective relative to common semiconductor components, such as silicon and silicon dioxide. The removal of the amorphous carbon can also be controlled such that a layer of amorphous carbon can remain on the contact surfaces of the moveable components in the micro device to prevent stiction between the moveable components.

Another potential advantage of the disclosed systems and methods is that anti-stiction materials can be applied to a plurality of micro devices after the micro devices are fabricated. Carbon-based anti-stiction material can be deposited isotropically onto the contact surfaces hidden under a micro structure by CVD. For example, carbon can be isotropically deposited by CVD on the lower surface of the mirror plate and the upper surfaces of the landing stops after a plurality of micro mirrors are fabricated on a semiconductor wafer.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

FIG. 1a illustrates a cross-sectional view of a micro mirror when the mirror plate is at an “on” position.

FIG. 1b illustrates a cross-sectional view of a micro mirror when the mirror plate is at an “off” position.

FIG. 2 is a perspective view of an array of rectangular shaped mirror plates.

FIG. 3 is a perspective view showing the top of a part of the control circuitry substrate for a mirror plate of FIG. 2.

FIG. 4 is a perspective view showing an array of mirror plate having curved edges.

FIG. 5 is a perspective view showing the top of a part of the control circuitry substrate for a mirror plate in FIG. 4.

FIG. 6 is an enlarged backside view of the mirror plates having curved leading and trailing edges.

FIG. 7 is a perspective bottom view showing the torsion hinges and their support posts under the cavities in the lower portion of a mirror plate.

FIG. 8 is a diagram illustrates a minimum spacing around the torsion hinge of a mirror plate when rotated 150 in one direction.

FIG. 9 is a manufacturing process flow diagram for a micro-mirror based spatial light modulator having the disclosed anti-stiction material.

FIG. 10-13 are cross-sectional side views of a part of a spatial light modulator illustrating one method for fabricating a plurality of support frames and the first level electrodes connected to the memory cells in the addressing circuitry.

FIG. 14-17 are cross-sectional side views of a part of a spatial light modulator illustrating one method for fabricating a plurality of support posts, second level electrodes, and landing stops on the surface of control substrate.

FIG. 18-20 are cross-sectional side views of a part of a spatial light modulator illustrating one method for fabricating a plurality of torsion hinges and supports on the support frame.

FIG. 21-23 are cross-sectional side views of a part of a spatial light modulator illustrating one method for fabricating a mirror plate with a plurality of hidden hinges.

FIG. 24-26 are cross-sectional side views of a part of a spatial light modulator illustrating one method for forming the reflective mirrors and releasing individual mirror plates of a micro mirror array.

FIGS. 27A-27I are cross-sectional views of forming a cantilever having an anti-stiction material.

FIG. 28 shows the cantilever in an activated position.

### DETAILED DESCRIPTION

In one example, the disclosed materials and methods are illustrated by the fabrication of spatial light modulator (SLM) based on a micro mirror array. A micro mirror array typically includes an array of cells, each of which includes a micro mirror plate that can be tilted about an axis and, furthermore, circuitry for generating electrostatic forces that tilt the micro mirror plate. In a digital mode of operation, the micro mirror plate can be tilted to stay at one of two positions. In an “on” position, the micro mirror plate directs incident light to form an assigned pixel in a display image. In an “off” position, the micro mirror plate directs incident light away from the display image.

A cell can include structures for mechanically stopping the micro mirror plate at the “on” position and the “off” position. These structures are referred to in the present specification as mechanical stops. The SLM operates by tilting a selected combination of micro mirrors to project light to form appropriate image pixels in a display image. Video applications typically require high frequency refresh rates. In an SLM, each instance of image frame refreshing can involve the tilting of all or many of the micro mirrors to a new orientation. Providing fast mirror tilt movement is therefore crucial to many SLM-based display devices.

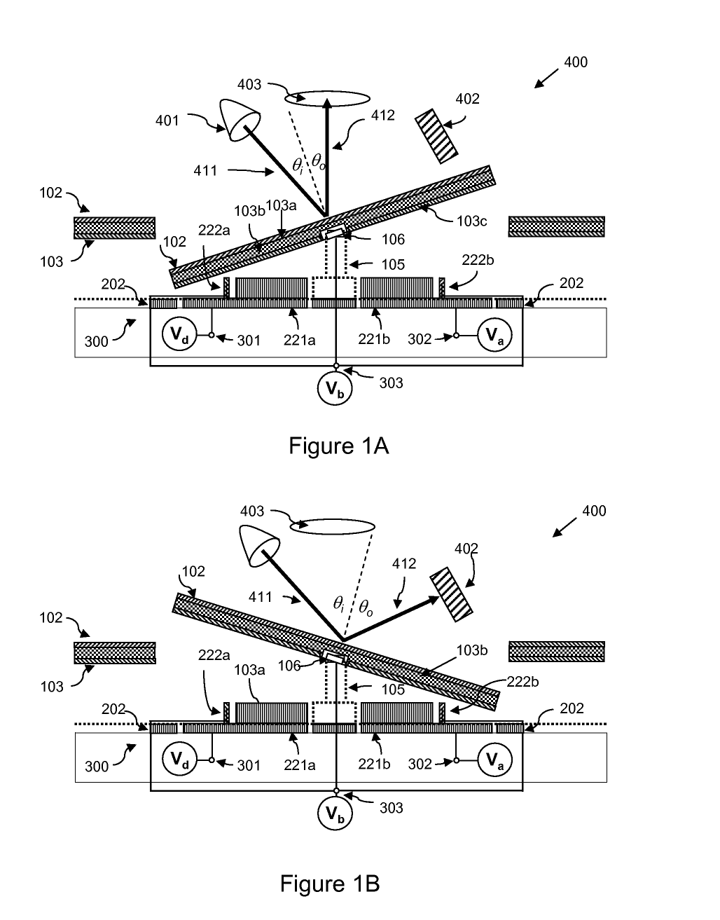

FIG. 1a shows a cross-section view of a portion of a spatial light modulator 400 where the micro mirror plate is in an “on” position. Incident light 411 from a source of illumination 401 is directed at an angle of incidence θi and is reflected at an angle of θo as reflected light 412 toward a display surface (not shown) through a projection pupil 403. FIG. 1b shows a cross-sectional view of the same part of the spatial light modulator where the mirror plate is rotated toward another electrode under the other side of hinge 106. The same incidental light 411 is reflected to form reflected light 412 at much larger angles θi and θo than in FIG. 1a. The angle of deflection of the deflected light 412 is predetermined by the dimensions of mirror plate 102 and the spacing between the lower surface of the mirror plate 102 and the springy landing stops 222a and 222b. The deflected light 412 exits toward a light absorber 402.

Referring to FIGS. 1a and 1b, the SLM 400 includes three major portions: the bottom portion including the control circuitry; the middle portion including a plurality of step electrodes, landing stops and hinge support posts; and the upper portion including a plurality of mirror plates with hidden torsion hinges and cavities.

The bottom portion includes a control substrate 300 with addressing circuitries to selectively control the operation of the mirror plates in the SLM 400. The addressing circuitries include an array of memory cells and word-line/bit-line interconnects for communication signals. The electrical addressing circuitry on a silicon wafer substrate can be fabricated using standard CMOS technology, and resembles a low-density memory array.

The middle portion of the high contrast SLM 400 includes step electrodes 221a and 221b, landing stops 222a and 222b, hinge support posts 105, and a hinge support frame 202. The multi-level step electrodes 221a and 221b are designed to improve the capacitive coupling efficiency of electrostatic torques during the angular cross over transition or rotation. By raising the surfaces of the step electrodes 221a and 221b near the hinge 106 area, the gap or spacing between the mirror plate 102 and the electrodes 221a and 221b is effectively narrowed. Since the electrostatic attractive force is inversely proportional to the square of the distance between the mirror plates and electrodes, this effect becomes apparent when the mirror plate is tilted to its landing positions. When operating in analog mode, highly efficient electrostatic coupling allows a more precise and stable control of the tilting angles of the individual micro mirror plate in the spatial light modulator. In a digital mode, the SLM requires much lower driving voltage potential in the addressing circuitry to operate. The height differences between the first level and the second levels of the step electrodes 221a and 221b may vary from 0.2 microns to 3 microns depending on the relative height of the gap between the first level electrodes and the mirror plate.

On the top surface of the control substrate, a pair of stationary landing stops 222a and 222b is designed to have the same height as that of second level of the step electrodes 221a and 221b for manufacturing simplicity. Other heights can also be selected. The landing stops 222a and 222b can provide a gentle mechanical touch-down for the mirror plate to land on each rotation. In addition, the landing stops 22a and 22b stop the mirror precisely at a pre-determined angle. Adding stationary landing stops 222a and 222b on the surface of the control substrate enhances the robotics of operation and prolongs the reliability of the devices. Furthermore, the landing stops 222a and 222b ease separation between the mirror plate 102 and its landing stop 222a and 222b. In some embodiments, to initiate mirror rotation, a sharp bipolar pulse voltage Vb is applied to the bias electrode 303, which is typically connected to each mirror plate 102 through its hinges 106 and hinge support posts 105. The voltage potential established by the bipolar bias Vb enhances the electrostatic forces on both side of the hinge 106. This strengthening is unequal on two sides at the landing position, due to the large difference in spacing between the landing stops 222a and 222b and mirror plate 102 on either side of the hinge 106. Though the increases of bias voltages Vb on the bottom layer 103c of mirror plate 102 has less impact on which direction the mirror plate 102 will rotate, a sharp increase of electrostatic forces F on the whole mirror plate 102 provides a dynamic excitation by converting the electromechanical kinetic energy into an elastic strain energy stored in the deformed hinges 106 and deformed landing stops 222a or 222b. After the bipolar pulse is released from the common bias Vb, the elastic strain energy of deformed landing stop 222a or 222b and the deformed hinges 106 is converted to the kinetic energy of the mirror plate as it springs and bounces away the landing stop 222a or 222b. This perturbation of the mirror plate toward the quiescent state enables a much smaller addressing voltage potential Va rotate the mirror plate 102 from one position to the other.

The hinge support frame 202 on the surface of control substrate 300 is designed to strengthen the mechanical stability of the pairs of hinge support posts 105, and retain the electrostatic potentials locally. For simplicity, the height of hinge support frames 202 is designed to be the same height as the first level of the step electrodes 221a and 221b. With a fixed size of mirror plate 102, the height of a pair of hinge support posts 105 in part determines the maximum deflection angles θ of each micro mirror.

The upper portion of the SLM 400 includes an array of micro mirrors, each with a flat optically reflective layer 103a on the upper surface and a pair of hinges 106 under a cavity in the lower portion of mirror plate 102. A pair of hinges 106 in the mirror plate 102 are fabricated to be part of the mirror plate 102 and are kept a minimum distance under the reflective surface to allow only a gap for a pre-determined angular rotation. By minimizing the distances from the rotation axis defined by the pair of hinges 106 to the upper reflective surfaces 103a, the spatial light modulator effectively significantly reduces the horizontal displacement of each mirror plate during rotation. In some implementations, the gaps between adjacent mirror plates in the array of the SLM are reduced to less than 0.2 microns to achieve a high active reflection area fill-ratio.

The structural materials used for SLMs are conductive and stable, with suitable hardness, elasticity, and stress. Ideally a single material can provide both the stiffness for the mirror plate 102 and the plasticity for the hinges 106 and still have sufficient strength to deflect without fracturing. In the present specification, such structural material is called electromechanical material. Furthermore, all the materials used in constructing the micro mirror array may be processed at temperatures up to 500° C., a typical process temperature range, without damaging the pre-fabricated circuitries in the control substrate.

In the implementation shown in FIGS. 1a and 1b, the mirror plate 102 includes three layers. A reflective top layer 103a is made of a reflective material, such as aluminum, and is typically about 600 angstrom thick. A middle layer 103b can be made of a silicon based material, such as amorphous silicon, typically between about 2000 to 5000 angstrom in thickness. A bottom layer 103c is made of titanium and is typically about 600 angstrom thick. As can be seen from FIGS. 1a and 1b, the hinges 106 can be implemented as part of the bottom layer 103c. The mirror plate 102 can be fabricated as described below.

According to an alternative embodiment, the materials of mirror plates 102, hinges 106, and the hinge support posts 105 can include aluminum, silicon, polysilicon, amorphous silicon, and aluminum-silicon alloys. The deposition of one or more layers of the mirror plates 102 can be accomplished by physical vapor deposition (PVD) such as by magnetron sputtering a single target containing either or both aluminum and silicon in a controlled chamber with temperature below 500° C. The structure layers may also be formed by PECVD.

According to another alternative embodiment, the materials of the mirror plates 102, hinges 106, and the hinge support posts 105 can be silicon, polysilicon, amorphous silicon, aluminum, titanium, tantalum, tungsten, molybdenum, silicides or alloys of aluminum, titanium, tantalum, tungsten, or molybdenum or combinations thereof. Refractory metals and their suicides are compatible with CMOS semiconductor processing and have relatively good mechanical properties. These materials can be deposited by PVD, by CVD, or by PECVD. The optical reflectivity may be enhanced by further depositing a layer of metallic thin-films, such as aluminum, gold, or their alloys depending on the applications, on the surfaces of mirror plate 102.

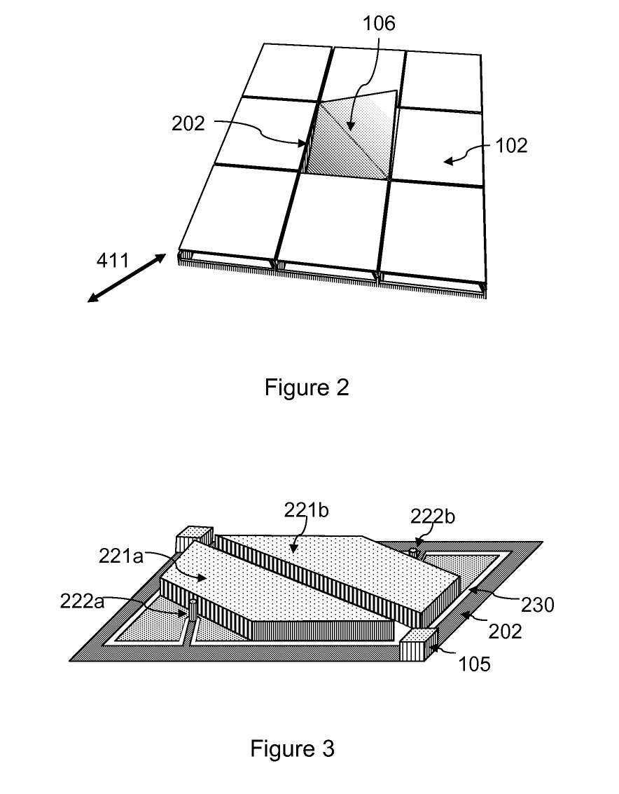

To achieve a high contrast ratio of the images formed by the micro mirrors, any scattered light from a micro mirror array should be reduced or eliminated. Most common interferences come from the diffraction patterns generated by the scattering of illumination from the leading and trailing edges of individual mirror plates. The solution to the diffraction problem is to reduce the intensity of the diffraction pattern and to direct the scattered light from the inactive area of each pixel away from the projection pupil. One method involves directing the incident light 411 45° to the edges of the square-shaped mirror plate 102, which is sometimes called a diagonal hinge or diagonal illumination configuration. FIG. 2 shows a perspective view showing the top of a part of the mirror array with each mirror plate 102 having a square shape using a diagonal illumination system. The hinges 106 of the mirror plate in the array are fabricated in a diagonal direction along two opposite corners of the mirror plate and perpendicular to the incident light 411. An advantage of a square shape mirror plate with a diagonal hinge axis is its ability to deflect the scattered light from the leading and trailing edges 450 away from the projection pupil 403. A disadvantage is that it requires the projection prism assembly system to be tilted to the edge of the SLM. The diagonal illumination has a low optical coupling efficiency when a conventional rectangular total internal reflection prism system is used to separate the light beams that are reflected by the mirror plate 102. The twisted focusing spot requires an illumination larger than the size of the rectangular micro mirror array surfaces in order to cover all active pixel arrays. A larger rectangular total internal reflection prism increases the cost, size, and the weight of the projection display.

FIG. 3 shows perspective view of the top of a part of the control circuitry substrate for the projection system with diagonal illumination configuration. The pair of step electrodes 221a and 221b is arranged diagonal accordingly to improve the electrostatic efficiency of the capacitive coupling to the mirror plate 102. The two landing stops 211a and 211b act as the landing stops for a mechanical landing of mirror plates 102 to ensure the precision of tilted angle θ and to overcome the contact stiction. Made of high spring constant materials, these landing stops 222a and 222b act as landing springs to reduce the contact area when mirror plates are snapped down. A second function of these landing stops 222 at the edge of two-level step electrodes 221a and 221b is their spring effect to separate the stops from the mirror plates 102. When a sharp bipolar pulse voltage potential Vb is applied on the mirror plate 102 through a common bias electrode 303 of mirror array, a sharp increase of electrostatic forces F on the whole mirror plate 102 provides a dynamic excitation by converting the electromechanical kinetic energy into an elastic strain energy stored in the deformed hinges 106. The elastic strain energy is converted back to the kinetic energy of mirror plate 102 as it springs and bounces away from the landing stop 222a or 222b.

The straight edges or corners of the mirror plates in a periodic array can create diffraction patterns that tend to reduce the contrast of projected images by scattering the incident light 411 at a fixed angle. In some embodiments, curved leading and trailing edges of the mirror plate in the array can reduce the diffractions due to the variation of scattering angles of the incident light 411 on the edges of mirror plate. In other embodiments, the reduction of the diffraction intensity into the projection pupil 403 while still maintaining an orthogonal illumination optics system is achieved by replacing the straight edges or fixed angular corner shapes of a rectangular shape mirror plate with at least one or a series curved leading and trailing edges with opposite recesses and extensions. The curved leading and trailing edges perpendicular to the incident light 411 can reduce the diffracted light directed into the projection system.

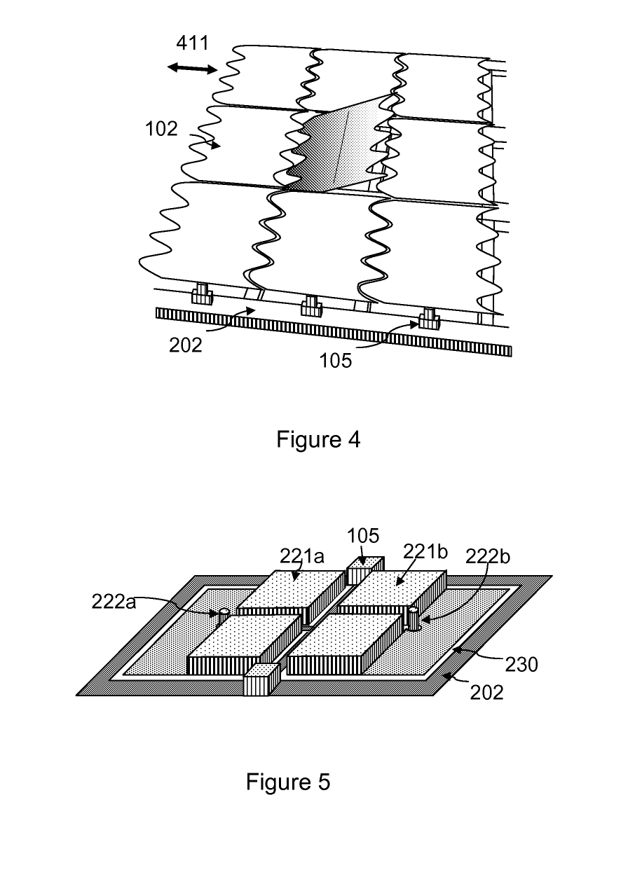

Orthogonal illumination has a higher optical system coupling efficiency, and requires a less expensive, smaller size, and lighter total internal reflection prism. However, since the scattered light from both leading and trailing edges of the mirror plate is scattered straightly into the projection pupil 403, it creates a diffraction pattern, reducing the contrast ratio of a SLM. FIG. 4 shows a perspective view of the top of a part of mirror array with rectangular mirrors for the projection system with orthogonal illumination configuration. The hinges 106 are parallel to the leading and trailing edges of the mirror plate and perpendicular to the incident light 411, that the mirror pixels in the SLM are illuminated orthogonally. In FIG. 4, each mirror plate in the array has a series of curves in the leading edge extension and trailing edge recession. The principle is that a curved edge weakens the diffraction intensity of scattered light and it further diffracts a large portion of scattered light at a variety of angles away from the optical projection pupil 403. The curvature radius of leading and trailing edges of each mirror plate r may vary depending on the numbers of curves selected. As the radius of curvature r becomes smaller, the diffraction reduction effect becomes more prominent. To maximize the diffraction reduction, according to some embodiments, a series of small radius curves r are designed to form the leading and trailing edges of each mirror plate in the array. The number of curves may vary depending on the size of mirror pixels, with a 10 microns size square mirror pixel, two to four curves on each leading and trailing edges provides low diffraction and is within current manufacturing capability.

FIG. 5 is a perspective view showing the top of a part of the control substrate 300 for a projection system with orthogonal illumination configurations. Unlike conventional flat electrodes, the two-level step electrodes 221a and 221b raised above the surface of control substrate 300 near the hinge axis narrows the effective gap or spacing between the flat mirror plate 102 and the lower step of the step electrodes the step electrodes 221a and 221b, which significantly enhances the electrostatic efficiency of capacitive coupling of mirror plate 102. The number of levels for the step electrodes 221a and 221b can vary such as from one to ten. However, the larger the number of levels for step electrodes 221a and 221b, the more complicated and costly it can be to manufacture the device. A more practical number may be from two to three. FIG. 5 also shows the mechanical landing stops 222a and 222b oriented perpendicular to the surface of control substrate 300. This low voltage driven and high efficiency micro mirror array design allows an operation of a larger total deflection angle (|θ|>15°) of micro mirrors to enhance the brightness and contrast ratio of the SLM.

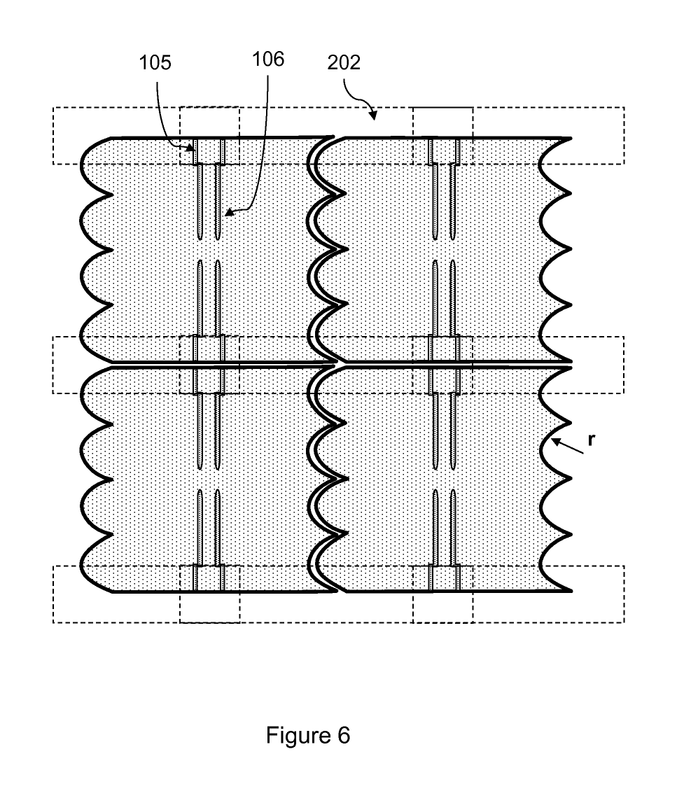

Another advantage of this reflective spatial light modulator is that it produces a high active reflection area fill-ratio by positioning the hinge 106 under the cavities in the lower portion of mirror plate 102, which almost completely eliminates the horizontal displacement of mirror plate 102 during an angular cross over transition. FIG. 6 shows an enlarged backside view of a part of the mirror array designed to reduce diffraction intensity using four curves on the leading and trailing edges for a projection system with an orthogonal illumination configuration. Again, pairs of hinges 106 are positioned under two cavities as part of the bottom layer 103c and are supported by a pair of hinge support posts 105 on top of hinge support frames 202. A pair of hinge support posts 105 has a width W in the cross section much larger than the width of the hinge 106. Since the distance between the axis between the pair of hinges 106 and the reflective surfaces of the mirror plate is kept minimal, a high active reflection area fill-ratio is achieved by closely packed individual mirror pixels without worrying the horizontal displacement. In one embodiment, mirror pixel size (a×b) is about 10 microns×10 microns, while the radius of curvature r is about 2.5 microns.

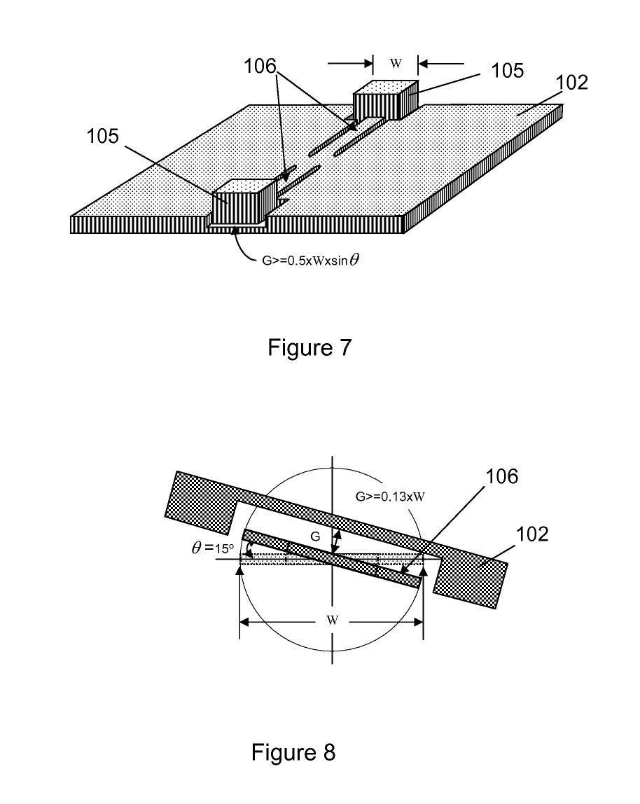

FIG. 7 shows an enlarged backside view of a part of the mirror plate showing the hinges 106 and the hinge support posts 105 under the cavities in the lower portion of a mirror plate 102. To achieve optimum performance, it is important to maintain a minimum gap G in the cavity where the hinges 106 are created. The dimension of the hinges 106 varies depending on the size of the mirror plates 102. In one implementation, the dimension of each hinge 106 is about 0.1×0.2×3.5 microns, while the hinge support post 105 has a square cross-section with each side W about 1.0 micron width. Since the top surfaces of the hinge support posts 105 are also under the cavities as lower part of the mirror plate 102, the gap G in the cavity needs to be high enough to accommodate the angular rotation of mirror plate 102 without touching the larger hinge support posts 105 when the mirror is at a predetermined angle θ. In order for the mirror plate to rotate to a pre-determined angle θ without touching the hinge support post 105, the gap of the cavities where hinges 106 are positioned must be larger than G=0.5×W×SIN(θ), where W is the cross-sectional width of hinge support posts 105.

FIG. 8 illustrates a minimum air gap spacing G around the hinge 106 of a mirror plate 102 when rotated 150 in one direction. The calculation indicates the gap spacing G of hinge 106 in the cavity must be larger than G=0.13 W. If a width of each side W of a square shape hinge support post 105 is 1.0 micron, the gap spacing G in the cavity should be larger than 0.13 microns. Without horizontal displacement during the transition rotation, the horizontal gap between the individual mirror plates in the micro mirror array may be reduced to less than 0.2 microns, which leads to a 96% active reflection area fill-ratio of the SLM described herein.

In one implementation, fabrication of a high contrast spatial light modulator is implemented as four sequential processes using standard CMOS technology. A first process forms a control silicon wafer substrate with support frames and arrays of first level electrodes on the substrate surface. The first level electrodes are connected to memory cells in addressing circuitry in the wafer. A second process forms a plurality of second level electrodes, landing stops, and hinge support posts on the surfaces of control substrate. A third process forms a plurality of mirror plates with hidden hinges on each pair of support posts. In a fourth process, the fabricated wafer is separated into individual spatial light modulation device dies before removing remaining sacrificial materials.

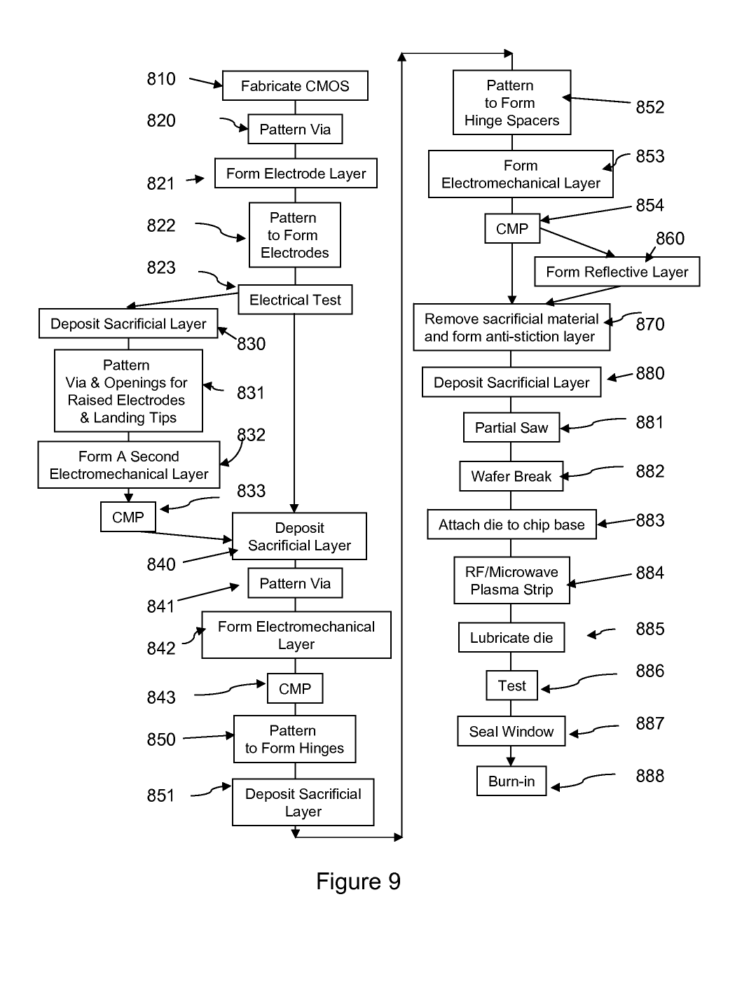

FIG. 9 is a flow diagram illustrating a process for making a high contrast spatial light modulator. The manufacturing processes starts by fabricating a CMOS circuitry wafer having a plurality of memory cells and word-line/bit-line interconnection structures for communicating signals as the control substrate using common semiconductor technology (step 810).

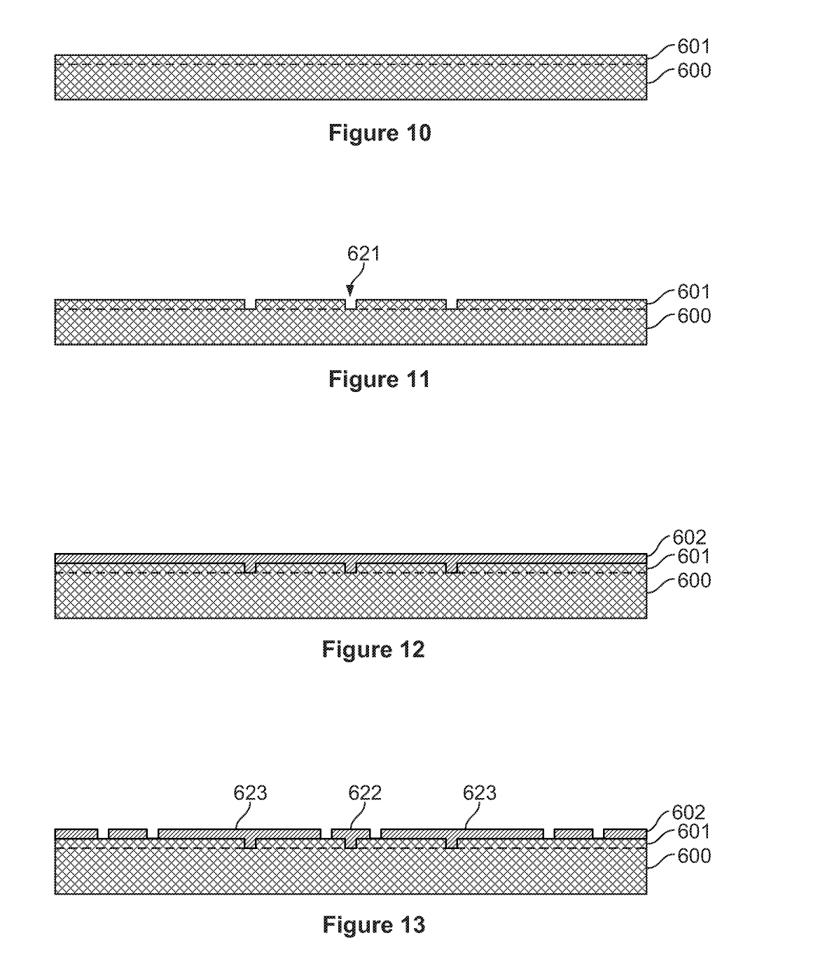

A plurality of first level electrodes and support frames are formed by patterning a plurality of vias through the passivation layer of circuitry, opening up the addressing nodes in the control substrate (step 820). To enhance the adhesion for a subsequent electromechanical layer, the via and contact openings are exposed to a 2000 watts of RF or microwave plasma with 2 torr total pressures of a mixture of O₂, CF₄, and H₂O gases at a ratio of 40:1:5 at about 250° C. temperatures for less than five minutes. An electromechanical layer is deposited by physical vapor deposition (PVD) or plasma-enhanced chemical vapor deposition (PECVD) depending on the materials selected filling via and forming an electrode layer on the surface of control substrate (step 821). The deposition of the electromechanical layer and the subsequent formation of the vias are illustrated in FIGS. 10 and 11, and discussed below in relation to FIGS. 10 and 11.

Then the electromechanical layer is patterned and anisotropically etched through to form a plurality of electrodes and support frames (step 822). The partially fabricated wafer is tested to ensure the electrical functionality before proceeding (step 823). The formation of electrodes and support frames are illustrated in FIGS. 12 and 13 and described in detail below in the related discussions.

According to some embodiments, the electromechanical layer deposited and patterned in the steps 821 and 822 includes a metal such as pure aluminum, titanium, tantalum, tungsten, molybdenum film, an aluminum poly-silicon composite, an aluminum-copper alloy, or an aluminum silicon alloy. While each of these metals has slightly different etching characteristics, they all can be etched in similar chemistry to plasma etching of aluminum. A two step process can be carried out to anisotropically etch aluminum metallization layers. First, the wafer is etched in inductively coupled plasma while flowing with BCl₃, Cl₂, and Ar mixtures at flow rates of 100 sccm, 20 sccm, and 20 sccm respectively. The operating pressure is in the range of 10 to 50 mTorr, the inductive coupled plasma bias power is 300 watts, and the source power is 1000 watts. During the etching process, the wafer is cooled with a backside helium gas flow of 20 sccm at a pressure of 1 Torr. Since the aluminum pattern can not simply be removed from the etching chamber into ambient atmosphere, a second oxygen plasma treatment step must be performed to clean and passivate the aluminum surfaces. In a passivation process, the surfaces of a partially fabricated wafer is exposed to a 2000 watts of RF or microwave plasma with 2 torr pressures of a 3000 sccm of H₂O vapor at about 250° C. temperatures for less than three minutes.

According to another embodiment, the electromechanical layer is silicon metallization, which can take the form of a polysilicon, a polycide, or a silicide. While each of these electromechanical layers has slightly different etching characteristics, they all can be etched in similar chemistry to plasma etching of polysilicon. Anisotropic etching of polysilicon can be accomplished with most chlorine or fluoride based feedstock, such as Cl₂, BCl₃, CF₄, NF₃, SF₆, HBr, and their mixtures with Ar, N₂, O₂, and H₂. The polysilicon or silicide layer (WSiₓ, or TiSiₓ, or TaSi) is etched anisotropically in inductively coupled plasma while flowing Cl₂, BCl₃, HBr, and HeO₂ gases at flow rates of 100 sccm, 50 sccm, 20 sccm, and 10 sccm respectively. In another embodiment, the polycide layer is etched anisotropically in a reactive ion etch chamber flowing Cl₂, SF₆, HBr, and HeO₂ gases at a flow rate of 50 sccm, 40 sccm, 40 sccm, and 10 sccm, respectively. In both cases, the operating pressure is in the range of 10 to 30 mTorr, the inductively coupled plasma bias power is 100 watts, and the source power is 1200 watts. During the etching process, the wafer is cooled with a backside helium gas flow of 20 sccm at a pressure of 1 Torr. A typical etch rate can reach 9000 angstroms per minute.

A plurality of second level electrodes can be fabricated on the surface of the control substrate to reduce the distance between the mirror plate and the electrode on the substrate, which improves the electrostatic efficiency. Landing stops can also be fabricated on the substrate to reduce stiction between the mirror plate and the substrate.

A layer of sacrificial material is deposited with a predetermined thickness on the surface of partially fabricated wafer (step 830). In accordance with the present specification, the sacrificial material can include amorphous carbon, polyarylene, polyarylene ether (which can be referred to as SILK), as hydrogen silsesquioxane (HSQ). Amorphous carbon can be deposited by CVD or PECVD. The polyarylene, polyarylene ether, and hydrogen silsesquioxane can be spin-coated on the surface. The sacrificial layer will first be hardened before the subsequent build up, the deposited amorphous carbon can harden by thermal annealing after the deposition by CVD or PECVD. SILK or HSQ can be hardened by UV exposure and optionally by thermal and plasma treatments.

The sacrificial layer is next patterned to form via and contact openings for a plurality of second level electrodes, landing stops, and support posts (step 831). A second electromechanical layer is then deposited by PVD or PECVD, depending on the materials selected, forming a plurality of second level electrodes, landing stops, and support posts (step 832). The second electromechanical layer is planarized to a predetermined thickness by CMP (step 833). The height of second level electrodes and landing stops can be less than one micron. Step 830 through step 833 can be repeated to build a number of steps in the step electrodes 221a and 221b. The number of repeated steps 830-833 is determined by the number of steps in the step electrodes 221a and 221b. The steps 830-833 can be bypassed (i.e., from step 823 directly to step 840) when a flat electrode is fabricated on the control substrate.

Once the electrodes and landing stops are formed on the CMOS control circuitry substrate, a plurality of mirror plates with hidden hinges on each pair of support posts are fabricated. Sacrificial materials are deposited with a predetermined thickness on the surface of partially fabricated wafer to form a sacrificial layer (step 840). Then sacrificial layer is patterned to form vias for a plurality of hinge support posts (step 841). The sacrificial layer is hardened before a deposition of electromechanical materials by PVD or PECVD, depending on materials selected to fill the vias, to form a thin layer for torsion hinges and of the mirror plates (step 842). The electromechanical layer is planarized to a predetermined thickness by CMP (step 843). The electromechanical layer is patterned with a plurality of openings to form a plurality of torsion hinges (step 850). To form a plurality of cavities in the lower portion of mirror plate and torsion hinges positioned under the cavity, sacrificial materials are again deposited to fill the opening gaps around the torsion hinges and to form a thin layer with a predetermined thickness on top of the hinges (step 851). The thickness can be slightly greater than G=0.5×W×SIN(θ), where W is the cross-sectional width of hinge support posts 105. The sacrificial layer is patterned to form a plurality of spacers on top of each torsion hinge (step 852). More electromechanical materials are deposited to cover the surface of partially fabricated wafer (step 853).

The sacrificial materials in the steps 840-851 can also be selected from the above disclosed materials, including amorphous carbon. The electromechanical layer is planarized to a predetermined thickness by CMP (step 854) before a plurality of openings are patterned. The reflectivity of the mirror surface may be enhanced by PVD deposition of a reflective layer (step 860). The material for the reflective layer can be aluminum, gold, and combinations thereof, or other suitable reflective materials. The thickness of the reflective layer can be 400 angstroms or less.

The amorphous-carbon based sacrificial materials can be removed through the openings to form a plurality of air gaps between individual mirror plates (step 870, option 1). The sacrificial materials disclosed in the present specification can be removed using dry processes such as isotropic plasma etching, microwave plasma, or activated gas vapor. The sacrificial material can be removed from below other layers of materials. The removal can also be highly selective relative to common semiconductor components. For example, amorphous carbon can be removed at a selectivity ratio of 8:1 relative to silicon and 15:1 relative to silicon oxide. Thus, the disclosed sacrificial materials can be removed with minimal wearing to the intended micro structures.

The removal of the amorphous-carbon-based sacrificial material can be controlled such that a thin layer of carbon material can remain on the contact surfaces between the mirror plate and the landing stops. For example, a wafer can contain one or a plurality of fabricated tiltable micro plates. Each mirror plate is supported by a hinge support post and is associated with one or more landing stops underneath the mirror plate. The removal of amorphous carbon can be accomplished by exposing the wafer to 2000 watts of radio frequency or microwave plasma in a mixture of O₂, CF₄, and H₂O gases at about 250° C. The gas pressure is controlled to about 2 torr total pressure. The ratio for the O₂, CF₄, and H₂O gases in the gas mixture is 40:1:5.

The processing parameters in the removal step are optimized such that the thicknesses of the carbon layers on the contact surfaces are sufficiently thick to prevent stiction between the contact surfaces during the micro mirror operations. For example, the removal step can be controlled to be shorter than about five minutes to ensure a carbon layer (699a and 699b in FIG. 26) is left on one or more contact surfaces between the mirror plates and their associated landing stops. Different thicknesses of carbon sacrificial layer and sized gaps for the plasma to reach the carbon during removal can affect the amount of time required to expose the carbon to the plasma. The thicknesses of the carbon layers (699a and 699b) on the contact surfaces can be controlled to be thicker than 0.3 nanometer. The carbon layer thickness on the contact surfaces can also be controlled to be thicker than 1.0 nanometer. The carbon layer can include one or more layers of carbon atoms.

An advantage of the carbon as a sacrificial material is that it can be removed by isotropic etching in dry processes. The dry removal process is simpler than the wet processes in cleaning the conventional sacrificial materials. Isotropic etching allows convenient removal of the disclosed sacrificial materials that are positioned under an upper structural layer such as a mirror plate, which cannot easily be accomplished by dry anisotropic etching processes. Another advantage of sacrificial material based on amorphous carbon is that it can be deposited and removed by conventional CMOS processes. Still another advantage of using amorphous carbon as a sacrificial material is that it can maintain high carbon purity and carbon does not usually contaminate most micro devices.

In some embodiments, the sacrificial material is polyarylene, polyarylene ether, HSQ, or a sacrificial material other than amorphous carbon. The polyarylene, polyarylene ether, and HSQ can be spin-coated on the surface. The sacrificial layer will first be hardened before the subsequent build up, the deposited amorphous carbon can harden by thermal annealing after the deposition by CVD or PECVD process. SILK or HSQ can be hardened by UV exposure and optionally thermal and plasma treatments. After the mirror plates are formed, these sacrificial materials can be substantially completely removed in dry processes such as isotropic plasma etching, microwave plasma, or activated gas vapor below the mirror plate (step 870, option 2).

The step 870 in these embodiments (option 2) includes an additional isotropic deposition of carbon material through the gaps between the adjacent mirror plates after the removal of the non-carbon-based sacrificial materials. The deposited carbon can exist in an amorphous state, diamond, graphite, or a poly-crystalline state. The deposition of carbon can be achieved by CVD. Layers of carbon material can be formed as the outer most layers on the lower surface of the mirror plates, the upper surface of the landing stops as well as other surfaces of the micro mirror. The amount of deposited carbon material can be controlled such that the carbon layers in the contact areas between the mirror plates and the landing stops are sufficiently thick to prevent stiction between the mirror plates and their associated landing stops. The carbon layer can include one or more layers of atomic carbons. For example, the carbon layer in the contact surfaces can be controlled to be more than 0.3 nanometer, more than 0.5 nanometer or more than 1.0 nanometer in thickness. In most applications, the carbon layer does not need to be thicker than the bottom layer 103c (which can be, for example, approximately 60 nanometer in thickness).

To separate the fabricated wafer into individual SLM device dies, a thick layer of sacrificial materials is deposited to cover the fabricated wafer surfaces for protection (step 880). Then the fabricated wafer is partially sawed (step 881) before separating into individual dies by scribing and breaking (step 882). The spatial light modulator device die is attached to the chip base with wire bonds and interconnects (step 883) before an RF or microwave plasma striping of the remaining sacrificial materials (step 884). The SLM device die is lubricated by exposing it to a PECVD coating of lubricants in the interfaces between the mirror plate and the surface of electrodes and landing stops (step 885) before an electro-optical functional test (step 886). Finally, the SLM device is hermetically sealed with a glass window lip (step 887) and sent to a burn-in process for reliability and robust quality control (step 888).

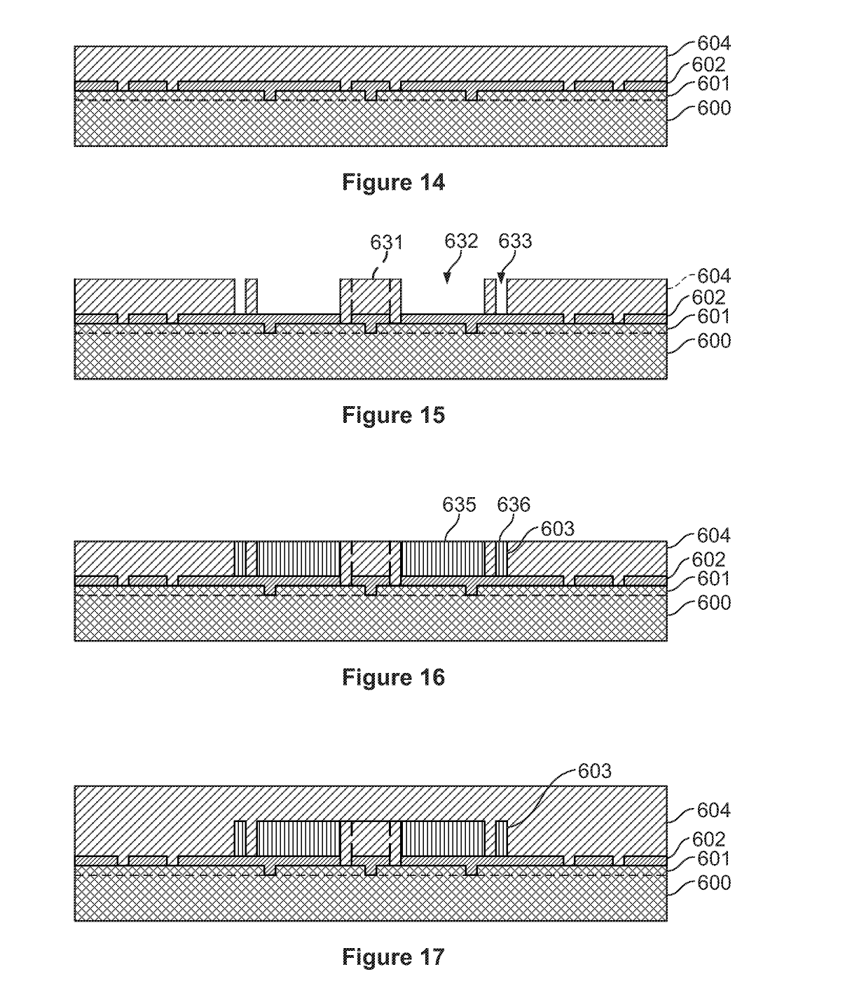

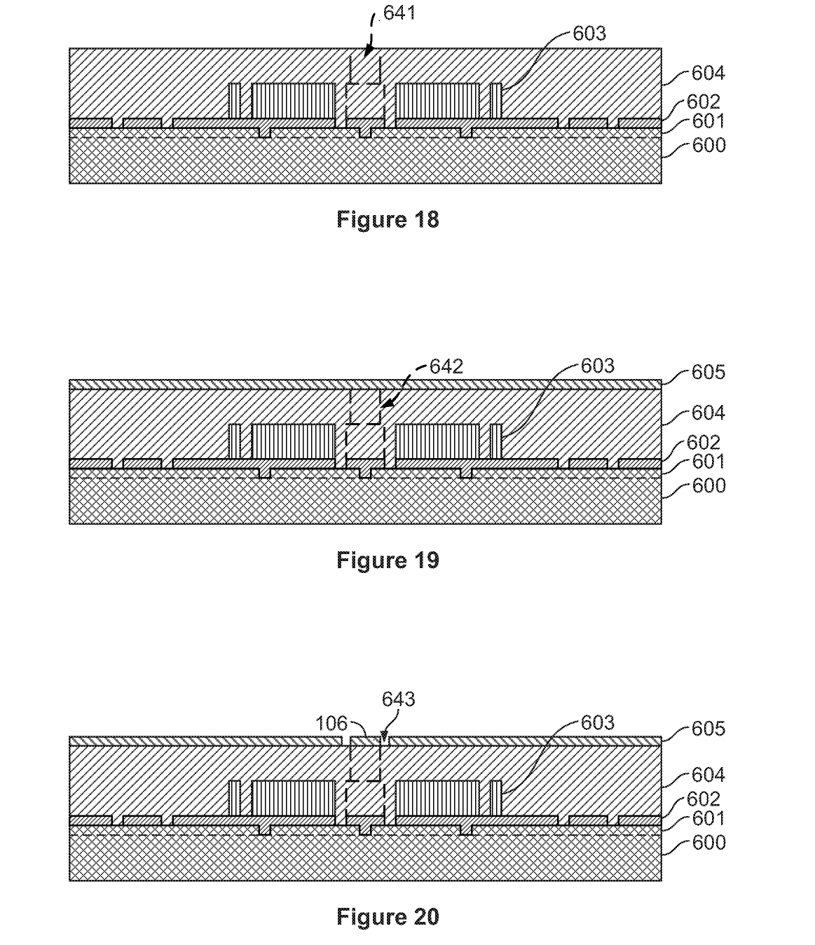

A more detailed description of each process to fabricate a high contrast spatial light modulator is illustrated in a series of cross-section diagrams. FIG. 10 to FIG. 13 are cross-sectional side views of a part of an SLM illustrating one method for fabricating a plurality of support frames and the first level electrodes connected to the memory cells in the addressing circuitry. FIG. 14 to FIG. 17 are cross-sectional side views of a part of an SLM illustrating one method for fabricating a plurality of support posts, second level electrodes, and landing stops on the surface of control substrate. FIG. 18 to FIG. 20 are cross-sectional side views of a part of an SLM illustrating one method for fabricating a plurality of torsion hinges and supports on the support frame. FIG. 21 to FIG. 23 are cross-sectional side views of a part of an SLM illustrating one method for fabricating a mirror plate with a plurality of hidden hinges. FIG. 23 to FIG. 26 are cross-sectional side views of a part of an SLM illustrating one method for forming the reflective mirrors and releasing individual mirror plates of a micro mirror array.

FIG. 10 is a cross-sectional view that illustrates the control silicon wafer substrate 600 after using standard CMOS fabrication technology. In one embodiment, the control circuitry in the control substrate includes an array of memory cells, and word-line/bit-line interconnects for communication signals. There are many different methods to make electrical circuitry that performs the addressing function. The DRAM, SRAM, and latch devices commonly known may all perform the addressing function. Since the mirror plate 102 area may be relatively large on semiconductor scales (for example, the mirror plate 102 may have an area of larger then 100 square microns), complex circuitry can be manufactured beneath micro mirror 102. Possible circuitry includes, but is not limited to, storage buffers to store time sequential pixel information, and circuitry to perform pulse width modulation conversions.

In a typical CMOS fabrication process, the control silicon wafer substrate is covered with a passivation layer 601 such as silicon oxide or silicon nitride. The passivated control substrate 600 is patterned and etched anisotropically to form via 621 connected to the word-line/bit-line interconnects in the addressing circuitry, shown in FIG. 11. According to another embodiment, anisotropic etching of dielectric materials, such silicon oxides or silicon nitrides, is accomplished with C₂F₆ and CHF₃ based feedstock and their mixtures with He and O₂. An exemplified high selectivity dielectric etching process includes the flow of C₂F₆, CHF₃, He, and O₂ gases at a ratio of 10:10:5:2 mixtures at a total pressure of 100 mTorr with inductive source power of 1200 watts and a bias power 600 watts. The wafers are then cooled with a backside helium gas flow of 20 sccm at a pressure of 2 torr. A typical silicon oxide etch rate can reach 8000 angstroms per minute.

Next, FIG. 12 shows that an electromechanical layer 602 is deposited by PVD or PECVD depending on the electromechanical materials selected. This electromechanical layer 602 is patterned to define regions where the hinge support frames 622 and the first steps of the step electrodes 623 corresponding to each micro mirror plate 102 will be located, as shown in FIG. 13. The patterning of the electromechanical layer 602 can be performed using the following steps. First, a layer of sacrificial material is spin coated to cover the substrate surface. Then the sacrificial layer is exposed to standard photolithography and developed to form predetermined patterns. The electromechanical layer is etched anisotropically through to form a plurality of via and openings. Once via and openings are formed, the partially fabricated wafer is cleaned by removing the residues from the surfaces and inside the openings. This can be accomplished by exposing the patterned wafer to 2000 watts of RF or microwave plasma with 2 torr total pressures of a mixture of O₂, CF₄, and H₂O gases at a ratio of 40:1:5 at about 250° C. temperatures for less than five minutes. Finally, the surfaces of electromechanical layer is passivated by exposing to a 2000 watts of RF or microwave plasma with 2 torr pressures of a 3000 sccm of H₂O vapor at about 250° C. temperatures for less than three minutes.

A plurality of second steps of the step electrodes 221a and 221b, landing stops 222a and 222b, and hinge support posts 105 are formed on the surface of partially fabricated wafer, through the following steps. A micron thick sacrificial material is deposited or spin-coated on the substrate surface to form a sacrificial layer 604, shown in FIG. 14. A sacrificial layer 604 built by amorphous carbon can harden by thermal annealing after CVD or PECVD. A sacrificial layer 604 based on HSQ or SILK can be hardened by UV exposure and optionally thermal and plasma treatments.

Then, sacrificial layer 604 is patterned to form a plurality of via and contact openings for second level electrodes 632, landing stops 633, and support posts 631 (location of opening for support post 631 shown in phantom) as shown in FIG. 15. To enhance the adhesion for subsequent electromechanical layer, the via and contact openings are exposed to a 2000 watts of RF or microwave plasma with 2 torr total pressures of a mixture of O₂, CF₄, and H₂O gases at a ratio of 40:1:5 at about 250° C. temperatures for less than five minutes. Electromechanical material 603 is then deposited to fill the via and contact openings. The filling is done by either PECVD or PVD depending on the materials selected. For the materials selected from the group consisting of aluminum, titanium, tungsten, molybdenum, and their alloys, PVD is a common deposition method in the semiconductor industry. For the materials selected from the group consisting of silicon, polysilicon, silicide, polycide, tungsten, and their combinations, PECVD is chosen as a method of deposition. The partially fabricated wafer is further planarized by CMP to a predetermined thickness slightly less than one micron shown in FIG. 16.

After the CMP planarization, FIG. 17 shows that another layer of sacrificial materials is deposited (in the case of amorphous carbon) or spin-coated (in the case of HSQ or SILK) to a predetermined thickness and hardened to form the gap under the torsion hinges. The sacrificial layer 604 is patterned to form a plurality of via 641 or contact openings for hinge support posts (shown in phantom), as shown in FIG. 18. In FIG. 19, electromechanical material is deposited to fill the via 641 to form support posts 642 (shown in phantom) and form a torsion hinge layer 605 on the surface. This hinge layer 605 is then planarized by CMP to a predetermined thickness. The thickness of hinge layer 605 formed here defines the thickness of the torsion hinge bar and the mechanical performance of the mirror plate later on.

The hinge layer 605 can have the thickness in the range of about 400 to 1200 angstroms. The CMP planarization can exert significant mechanical strain on the thin hinge layer 605. A drawback of the conventional sacrificial material based on photo resist is that it may not be able to provide the mechanical strength to support hinge layer 605. In contrast, the sacrificial materials (amorphous carbon, HSQ, or SILK) disclosed in the present specification have higher mechanical strength after hardening comparing to the hardened photo resist. The disclosed sacrificial materials can much better support the hinge layer 605 during the planarization of the hinge layer 605, which allow the hinge layer 605 to stay physically intact and reducing fabrication failure rate.

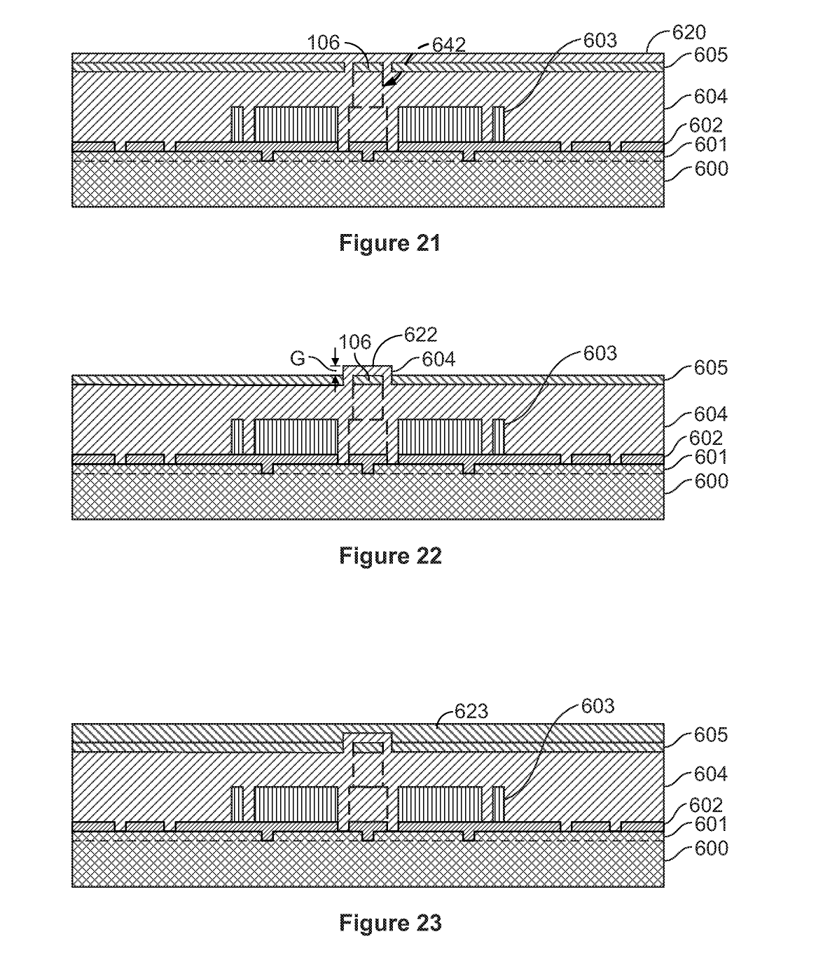

The hinge layer 605 of the partially fabricated wafer is patterned and anisotropically etched with openings 643 to form a plurality of hinges 106 in the electromechanical layers 605, as shown in FIG. 20. More sacrificial material is deposited to fill the openings 643 surrounding each hinge and to form a thin sacrificial layer 620 with a pre-determined thickness on the surface, as shown in FIG. 21. The thickness of the sacrificial layer 620 defines the height of the spacers on top of each hinge 106. The sacrificial layer 620 is then patterned to form a plurality of spacers 622 on top of each hinge 106, as shown in FIG. 22. Since the top surfaces of support posts 642 are also under the cavities as the lower part of the mirror plate 102, the gap G in the cavity needs to be high enough to accommodate the angular rotation of mirror plate 102 without touching the larger hinge support posts 105 when the mirror plate 102 is at a pre-determined angle θ.

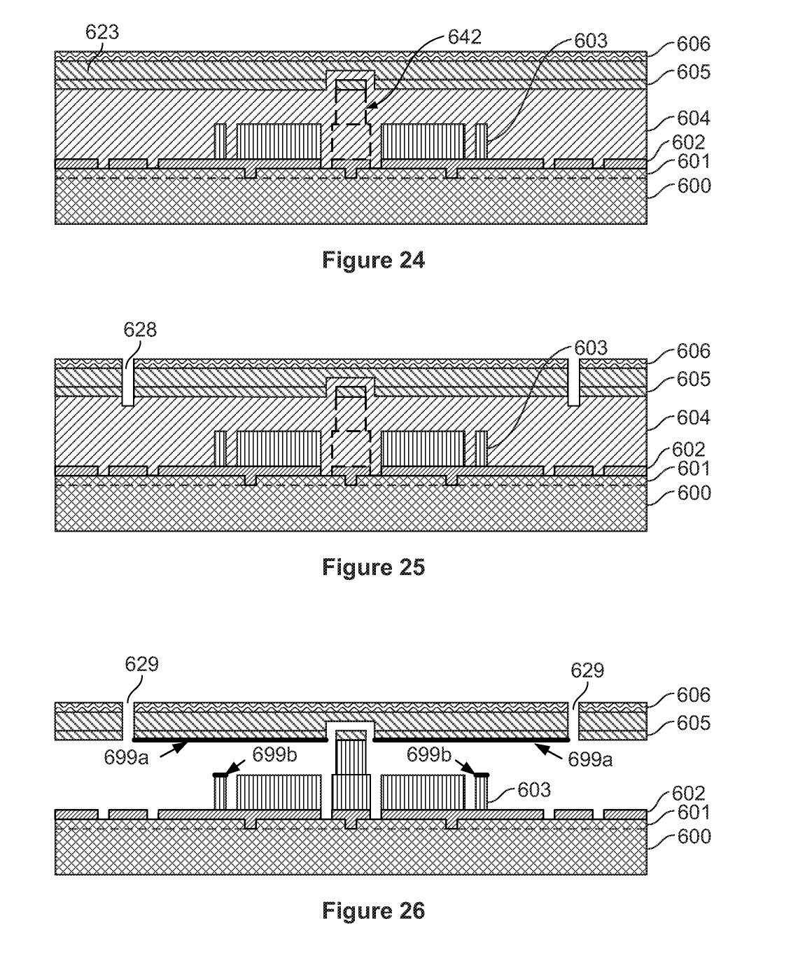

To form a mirror plate, with the hinges 106 under each cavity in the lower portion of mirror plate 102, more electromechanical material 623 is deposited to cover a plurality of sacrificial spacers, as shown in FIG. 23. In some cases, a CMP planarization step is added to ensure a flat reflective surface of electromechanical layer 605 has been achieved before etching to form individual mirrors. The total thickness of the electromechanical layer 605, 623 will ultimately be the approximate thickness of the mirror plate 102 eventually fabricated. The surface of the partially fabricated wafer can be planarized by CMP to a predetermined thickness of mirror plate 102. The thickness of the mirror plate 102 can be between 0.3 microns to 0.5 microns. If the electromechanical material is aluminum or its metallic alloy, the reflectivity of the mirror is high enough for most of display applications. For some other electromechanical materials or for other applications, reflectivity of the mirror surface may be enhanced by deposition of a reflective layer 606 of 400 angstroms or less thickness selected from the group consisting of aluminum, gold, their alloys, and combinations, as shown in FIG. 24. The reflective surface 606 of the electromechanical layer is then patterned and etched anisotropically through to form recesses 628 which define the boundaries of a plurality of individual mirror plates, as shown in FIG. 25.

FIG. 26 shows the device after the sacrificial materials 604, 620 are removed and residues are cleaned through a plurality of gaps between each individual mirror plate in the micro mirror array. Adjacent mirror plates are separated by gaps 629. When the sacrificial materials 604 is amorphous carbon, the amorphous-carbon-based sacrificial materials 604 is partially removed to allow carbon layers 699a and 699b to be respectively formed on the lower surfaces of the electromechanical layer 605 and the upper surfaces of the landing stops 603 (carbon layers formed on the surfaces of the steps electrodes and hinge support post or not shown in FIG. 26 for viewing clarity). As discussed previously, the thicknesses of the carbon layers 699a and 699b are thick enough to prevent stiction between the mirror plate 102 and landing stops 603 (or 222a and 222b) (step 870).

When the sacrificial material 604 is not carbon based, the sacrificial material 604 can be completely removed. A carbon material can be deposited isotropically on the contact surfaces through gaps 629. The deposition can be conducted by CVD. Carbon layers 699a and 699b can be respectively formed on the lower surfaces of the electromechanical layer 605 and the upper surfaces of the landing stops 603.

In a real manufacturing environment, more processes are required before delivering a functional spatial light modulator for video display application. After reflective surface 606 on electromechanical layer 605 is patterned and etched anisotropically through to form a plurality of individual mirror plates, more sacrificial materials are deposited to cover the surface of fabricated wafer. With its surface protected by a layer of sacrificial materials, the fabricated wafer is processed using convention semiconducting processing methods to form individual device dies. In a packaging process, the fabricated wafer is partially sawed (step 881) before being separated into individual dies by scribing and breaking (step 882). The spatial light modulator device die is attached to the chip base with wire bonds and interconnects (step 883) before striping the remaining sacrificial materials and residue in the structures (step 884). Cleaning can be accomplished by exposing the patterned wafer to 2000 watts of RF or microwave plasma with 2 torr total pressures of a mixture of O₂, CF₄, and H₂O gases at a ratio of 40:1:5 at about 250° C. temperatures for less than five minutes. Finally, the surfaces of electromechanical and metallization structures are passivated by exposure to 2000 watts of RF or microwave plasma with 2 torr pressures of a 3000 sccm of H₂O vapor at about 250° C. temperatures for less than three minutes.

In some implementations, the SLM device die is further coated with an anti-stiction layer inside the opening structures by exposing to a PECVD of fluorocarbon at about 200° C. temperatures for less than five minutes (step 885) before plasma cleaning and electro-optical functional test (step 886). Finally, the SLM device is hermetically sealed with a glass window lip (step 887) and sent to burn-in process for reliability and robust quality control (step 888).

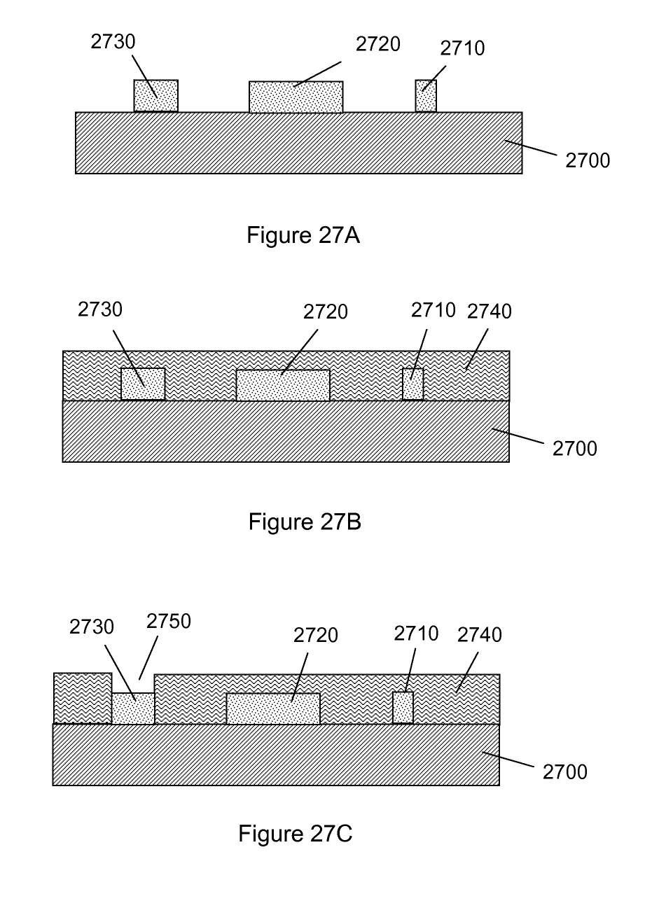

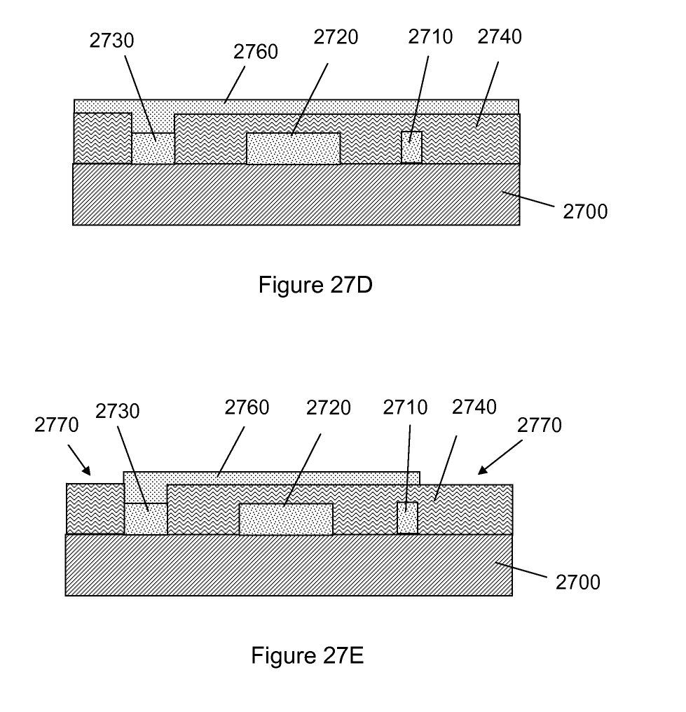

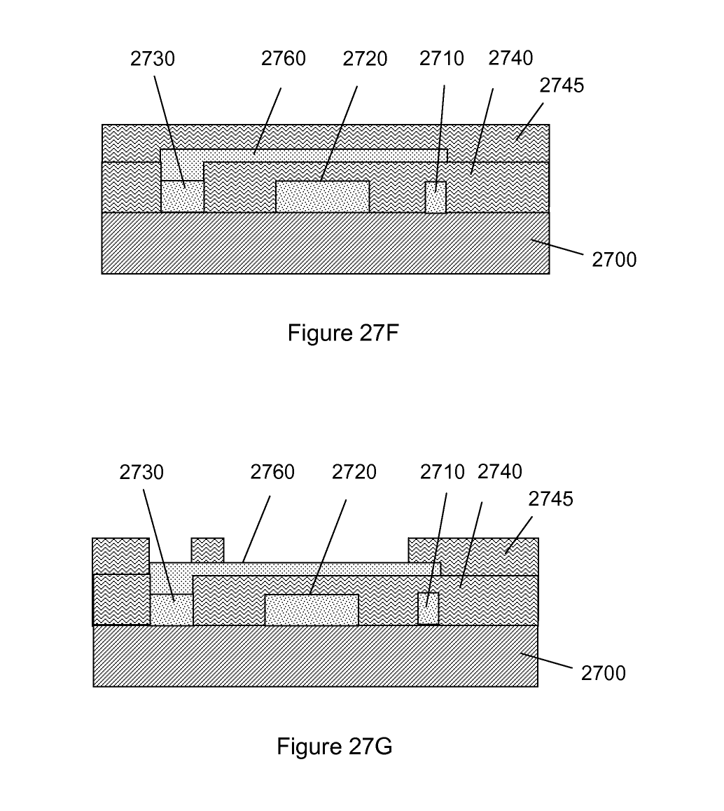

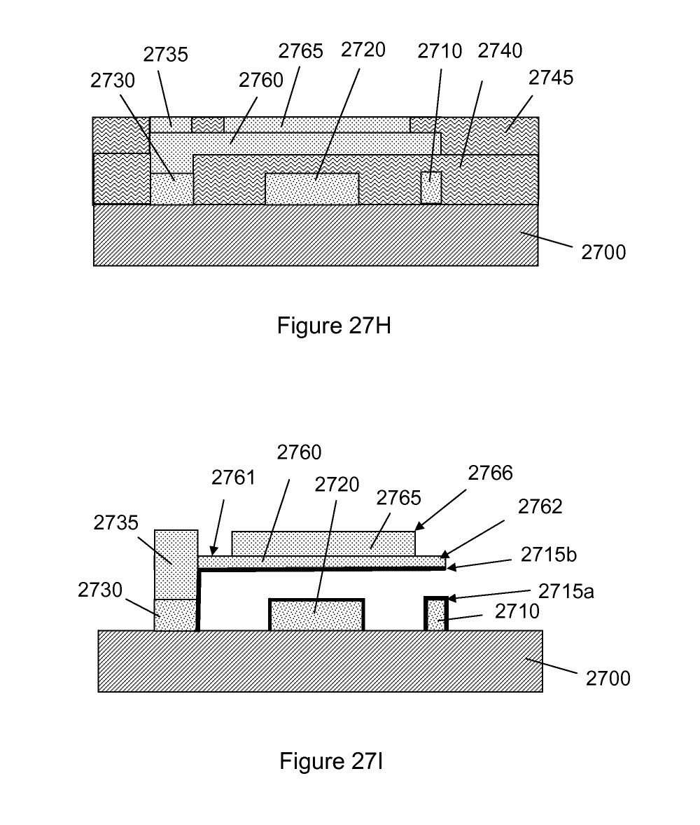

In another example of a device potentially affected by stiction, FIGS. 27A-27I illustrate a manufacturing process for fabricating a cantilever 2766 having an anti-stiction material coating. As shown in FIG. 27A, a mechanical stop 2710, an electrode 2720, and a lower post portion 2730 are built on a substrate 2700 using one or more conductive materials. The conductive materials can include a metallic material, doped silicon, etc. The substrate 2700 can be made of silicon or complementary metal oxide semiconductor (CMOS) that comprises circuitry for transmitting electric signals for controlling the movement of the cantilever 2766 to be formed.

A layer of sacrificial material 2740 is next introduced over the substrate 2700, the mechanical stop 2710, an electrode 2720, and a lower post portion 2730. The sacrificial material 2740 can include amorphous carbon, polyarylene, polyarylene ether (which can be referred to as SILK), and hydrogen silsesquioxane (HSQ).

The layer of sacrificial material 2740 is then etched to form a recess 2750 to expose the upper surface of the lower post portion 2730, as shown in FIG. 27C. The sacrificial material 2740 is hardened.

A cantilever layer 2760 is next deposited over the sacrificial material 2740 and in the recess 2750 over the lower post portion 2730, as shown in FIG. 27D. The cantilever layer 2760 can be made of a conductive material such as a metal, doped silicon, etc. Optionally, the cantilever layer is planarized. The cantilever layer 2760 is then etched in areas 2770 to expose the upper surface of the sacrificial material 2740, as shown in FIG. 27E.

A second layer of sacrificial material 2745 is next introduced over the cantilever layer 2760 and the previously introduced sacrificial material 2740, as shown in FIG. 27F. The sacrificial material 2745 is hardened. The sacrificial material 2745 is etched to expose the middle portion of the cantilever layer 2760 and the area of the upper surface above the lower post portion 2730. A conductive material is next deposited over the etched areas to form an upper post portion 2735 and an upper cantilever portion 2765, as shown in FIG. 27H. The surfaces of the upper post portion 2735 and the upper cantilever portion 2765 can planarized.

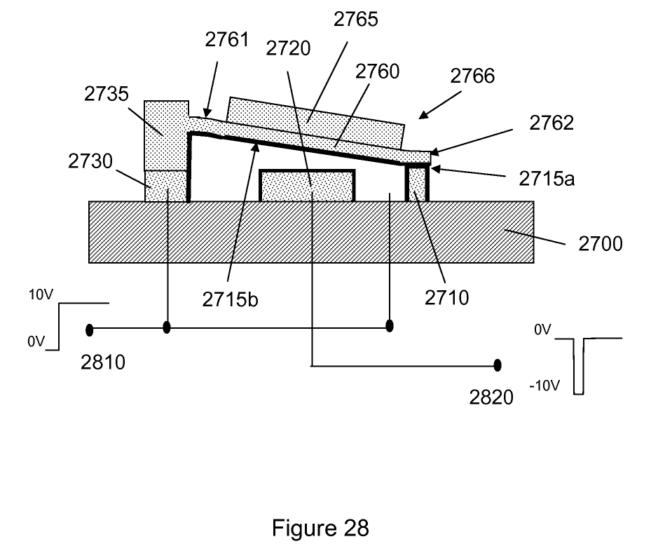

The sacrificial materials 2740 and 2745 are subsequently removed to form a cantilever 2766 including the cantilever layer 2760 and the upper cantilever portion 2765 as shown in FIG. 27I. The cantilever layer 2760 includes a cantilever hinge portion 2761 and cantilever tip portion 2762. The cantilever hinge portion 2761 connects the cantilever 2766 with the upper post portion 2735 and allows the cantilever 2766 to easily deflect toward the substrate 2700, as shown in FIG. 28. The cantilever tip portion 2762 can contact with the mechanical stop 2710 to stop the deflection of the cantilever 2766.

The removal of the sacrificial materials 2740 and 2745 can be conducted using a dry process, such as isotropic plasma etching, microwave plasma, or activated gas vapor. When the sacrificial material 2740 is amorphous carbon, the removal of the amorphous carbon can be controlled such that carbon layers 2715a and 2715b remain and respectively form on the upper surface of the mechanical stop 2710 and the lower surface of the cantilever layer 2760. The processing parameters for the removal step can be optimized such that the thicknesses of the carbon layers on the contact surfaces are sufficient to prevent stiction between the cantilever layer 2760 and the mechanical stop 2710 during the cantilever operations (shown in FIG. 28).

The removal of amorphous carbon in the sacrificial material 2740 can be accomplished by exposing the wafer to 2000 watts of radio frequency or microwave plasma in a mixture of O₂, CF₄, and H₂O gases at about 250° C. The gas pressure is controlled to about 2 torr total pressure. The removal step can be controlled to be shorter than about five minutes to ensure carbon layers remain on the lower surface of the cantilever layer 2760 and the upper surface of the mechanical 2710. The thicknesses of the carbon layers 2715a and 2715b can be controlled to be thicker than 0.3 nanometer or thicker than 1.0 nanometer. The carbon layers 2715a and 2715b can include one or more layers of carbon atoms.

In some embodiments, the sacrificial materials 2740 and 2745 can include polyarylene, polyarylene ether (which can be referred to as SILK), hydrogen silsesquioxane (HSQ), and materials other than amorphous carbon. The polyarylene, polyarylene ether, and hydrogen silsesquioxane can be spin-coated on the surface. The sacrificial materials 2740 and 2745 will first be hardened before the subsequent build up. SILK or HSQ can be hardened by UV exposure and optionally thermal and plasma treatments. After the cantilever layer 2766 is formed, the sacrificial materials 2740 and 2745 can be removed in a dry process such as isotropic plasma etching, microwave plasma, or activated gas vapor below the cantilever layer 2760.

After the removal of the non-carbon-based sacrificial materials, a carbon material can be isotropically deposited. The carbon material can be deposited by CVD to form the carbon layers 2715a and 2715b respectively on the upper surface of the mechanical stop 2710 and the lower surface of the cantilever layer 2760. The deposited carbon can exist in an amorphous state, or a poly-crystalline state. The amount of deposited carbon material can be controlled such that the carbon layers 2715a and 2715b are sufficiently thick to prevent stiction between the cantilever layer 2760 and the mechanical stop 2710. The carbon layers 2715a and 2715b can each include one or more mono-layers of atomic carbons. For example, the carbon layers 2715a and 2715b can be controlled to be more than 0.3 nanometer in thickness or more than 0.5 nanometer in thickness.

An advantage of the disclosed sacrificial materials is that they can be removed by isotropic etching in dry processes. The dry removal process is simpler than the wet processes in cleaning the conventional sacrificial materials. Isotropic etching allows convenient removal of the disclosed sacrificial materials that are positioned under an upper structural layer such as the cantilever, which cannot easily be accomplished by dry anisotropic etching processes. Another advantage of sacrificial material based on amorphous carbon is that it can be deposited and removed by conventional CMOS processes. Still another advantage of using amorphous carbon as a sacrificial material is that it can maintain high carbon purity and carbon does not usually contaminate to most micro devices.

FIG. 28 shows the cantilever 2766 in its activated state. The electrode 2810 in the substrate 2700 can control the electric potential of the cantilever layer 2760 through the electrically conductive materials in the upper post portion 2735 and the lower post portion 2730. The upper post portion 2735 and the lower post portion 2730 not only support the cantilever 2766, but also provide an appropriate space between the cantilever 2766 and the mechanical stop 2710 to define the proper deflection angle. The mechanical stop 2710 is also controlled to be at the same electric potential. For example, a positive 10 V pulse can be applied to the cantilever layer 2760 and the mechanical stop 2710. A −10V voltage pulse can be applied to the electrode 2720 via an electrode 2820. The electrostatic potential difference between the cantilever layer 2760 and the mechanical stop 2710 can produce an attractive force to deflect bend the cantilever 2766 downward. The cantilever 2766 can bend in the thinner cantilever hinge portion 2761 while remaining substantially undistorted in the upper cantilever portion 2765 the portion of the cantilever 2760 under the upper cantilever portion 2765.

The movement of the cantilever can be stopped by the mechanical stop 2710 when the lower surface of the cantilever tip portion 2762 and the upper surface of the mechanical stop 2710 come to contact with each other, that is, when the carbon layers 2715a and 2715b are in contact with each other. The cantilever tip portion 2762 can be subject to mechanical distortion under the upward force exerted by the mechanical stop 2710. The distortion can store elastic energy which can be released and cause the cantilever 2766 to spring back when the electrostatic attractive force on the cantilever 2766 is removed. The presence of the carbon layers 2715a and 2715b can reduce adhesion at the interface, which prevents stiction between the cantilever layer 2760 and the mechanical stop 2710 and assures that the cantilever 2766 restores to its undistorted position.

Although multiple embodiments have been shown and described, it will be understood by persons skilled in the relevant art that various changes in form and details can be made therein without departing from the spirit and scope. The disclosed sacrificial materials can be applied to many other types of micro devices in addition to the examples described above. For example, the disclosed sacrificial materials and the methods can be used to form micro mechanical devices, micro electrical mechanical devices (MEMS), microfluidic devices, micro sensors, micro actuators, micro display devices, printing devices, and optical waveguide. The disclosed sacrificial materials and the methods are generally suitable for the fabrication of micro devices comprising cavities, recesses, micro bridges, micro tunnels, or overhanging micro structures, such as cantilevers. The disclosed sacrificial materials and methods can be advantageously applied to fabricate such micro devices over substrates that contain electronic circuits. Furthermore, the disclosed sacrificial materials and methods are particularly suitable to fabricate micro devices over substrates containing electronic circuit wherein high processing is required.

What is claimed is:

1. A method of fabricating a micro structure, comprising:
forming a first structure portion on a substrate;
disposing a sacrificial material over the first structure portion;
depositing a layer of a first structural material over the sacrificial material and the substrate;
removing at least a portion of the sacrificial material to form a second structure portion in the layer of the first structural material, wherein the second structure portion is connected with the substrate and is movable between a first position in which the second structure portion is separated from the first structure portion and a second position in which the second structure portion is in contact with the first structure portion; and
forming a carbon layer on at least one of a surface of the second structure portion and a surface of the first structure portion to reduce stiction between the second structure portion and the first structure portion.

2. The method of claim 1, wherein the step of forming a carbon layer comprises depositing carbon by CVD on the surface of the second structure portion or on the surface of the first structure portion.

3. The method of claim 1, wherein the carbon layer is thicker than 0.3 nanometer.

4. The method of claim 3, wherein the carbon layer is thicker than 1.0 nanometer.

5. The method of claim 1, wherein the sacrificial material comprises amorphous carbon.

6. The method of claim 5, wherein the carbon layer comprises amorphous carbon not removed in the step of removing a portion of the sacrificial material.

7. The method of claim 5, wherein the step of disposing the sacrificial material comprises depositing carbon over the first structure portion by CVD or PECVD.

8. The method of claim 1, wherein the step of removing a portion of the sacrificial material comprises removing essentially all of the sacrificial material.

9. The method of claim 8, wherein the step of forming a carbon layer comprises depositing carbon on at least one of the surface of the second structure portion and the surface of the first structure portion after the step of removing.

10. The method of claim 8, wherein the sacrificial layer comprises a material selected from the group consisting of polyarylene, polyarylene ether, and hydrogen silsesquioxane.

11. The method of claim 1, wherein the carbon layer comprises an amorphous structure or in a polycrystalline phase.

12. The method of claim 1, further comprising planarizing the sacrificial material prior to depositing the layer of the first structural material over the sacrificial material.

13. The method of claim 1, further comprising:
forming a mask over the layer of the first structural material;
selectively removing the first structural material not covered by the mask to form an opening in the layer of the first structural material; and
applying an etchant through the opening to remove the sacrificial material.

14. The method of claim 1, wherein at least part of the second structure portion is electrically conductive.

15. The method of claim 1, wherein a lower surface of the second structure portion is configured to contact an upper surface of the first structure portion in the second position and the carbon layer is formed on the lower surface of the second structure portion or the upper surface of the first structure portion.

16. The method of claim 1, wherein at least one of the first structure portion and the second structure portion comprises a material selected from the group consisting of titanium, tantalum, tungsten, molybdenum, aluminum, aluminum-silicon alloys, silicon, amorphous silicon, polysilicon, silicide and a combination thereof.

17. The method of claim 1, wherein the second structure portion comprises a tiltable mirror plate and a post that supports the tiltable mirror plate.

18. The method of claim 1, wherein the step of forming comprises forming a carbon layer on a surface of the second structure portion.

19. The method of claim 1, wherein the step of forming comprises forming a carbon layer on a surface of the first structure portion.

20. A method of fabricating a tiltable micro mirror plate, comprising:
forming a post on a substrate;
forming projection on the substrate; disposing a sacrificial material over the substrate;
depositing one or more layers of structural materials over the sacrificial material;
removing at least a portion of the sacrificial material to form the tiltable micro mirror plate in connection with the post, wherein the tiltable micro mirror plate is movable between a first position in which the tiltable micro mirror plate is separated from the projection and a second position in which the tiltable micro mirror plate is in contact with the projection on the substrate; and
forming a carbon layer on at least one of a surface of the micro mirror plate and a surface of the projection on the substrate to reduce stiction between the micro mirror plate and the projection on the substrate.

21. The method of claim 20, wherein the step of forming a carbon layer comprises depositing carbon by CVD on the surface of the micro mirror plate or on the surface of the projection on the substrate.

22. The method of claim 20, wherein the carbon layer is thicker than 0.3 nanometer.

23. The method of claim 22, wherein the carbon layer is thicker than 1.0 nanometer.

24. The method of claim 20, wherein the sacrificial material comprises amorphous carbon.

25. The method of claim 24, wherein the carbon layer comprises amorphous carbon not removed in the step of removing a portion of the sacrificial material.

26. The method of claim 24, wherein the step of disposing the sacrificial material comprises depositing carbon by CVD or PECVD over the substrate.

27. The method of claim 20, wherein the step of removing comprises removing at least a portion of the sacrificial material by plasma etching.

28. The method of claim 20, further comprising planarizing the sacrificial material prior to depositing the one or more layers of structural materials over the sacrificial material.

29. The method of claim 20, further comprising:
forming a mask over the one or more layers of structural materials;
selectively removing the structural materials not covered by the mask to form an opening in the one or more layers of structural materials; and
applying an etchant through the opening to remove the sacrificial material.

30. The method of claim 20, wherein the projection on the substrate includes a tip that is configured to contact the lower surface of the tiltable micro mirror plate in the second position.

31. The method of claim 30, wherein the carbon layer is formed on the lower surface of the tiltable micro mirror plate or on the upper surface of the tip.

32. The method of claim 20, wherein depositing the one or more layers of structural materials over the sacrificial material comprises the steps of:
depositing a conductive material to form a lower layer of the tiltable micro mirror plate;
depositing a structural material over the lower layer to form a middle layer for the tiltable micro mirror plate; and
depositing a reflective material over the middle layer to form an upper layer of the tiltable micro mirror plate.

33. The method of claim 20, wherein the structural material comprises a material selected from the group consisting of titanium, tantalum, tungsten, molybdenum, aluminum, aluminum-silicon alloys, silicon, amorphous silicon, polysilicon, silicide and a combination thereof.

34. The method of claim 20, wherein the step of removing a portion of the sacrificial material comprises removing essentially all of the sacrificial material.

35. The method of claim 34, wherein the step of forming a carbon layer comprises depositing carbon on at least one of the surface of the second structure portion and the surface of the first structure portion after the step of removing.

36. The method of claim 34, wherein the sacrificial layer comprises a material selected from the group consisting of polyarylene, polyarylene ether, and hydrogen silsesquioxane.

37. The method of claim 20, wherein the carbon layer comprises an amorphous structure or in a polycrystalline phase.

38. A micro device, comprising:
a landing stop on a substrate;
a post on the substrate;
a deflectable member in connection with the post;
a component in connection with the deflectable member, wherein the component is movable between a first position in which the component is separated from the landing stop and a second position in which the component is in contact with the landing stop; and
a carbon layer on at least one of a surface of the component or a surface of the landing stop to reduce stiction between the component and the landing stop on the substrate.

39. The micro device of claim 38, wherein the component comprises a reflective surface.

40. The micro device of claim 38, wherein the component comprises a deflectable tip configured to contact with the landing stop, and the carbon layer is formed on a surface of the deflectable tip.

41. The micro device of claim 38, further comprising an electrode on the substrate, wherein at least part of the component is electrically conductive.

42. The micro device of claim 41, wherein the component is configured to move between the first position and the second position in response to one or more voltage signals applied to at least one of the electrode or the electrically conductive part of the component.

43. The micro device of claim 38, wherein a lower surface of the component is configured to contact an upper surface of the landing stop in the second position, and wherein the carbon layer is formed on the lower surface of the component or the upper surface of the landing stop.

44. The micro device of claim 38, wherein the carbon layer is thicker than 0.3 nanometer.

45. The micro device of claim 44, wherein the carbon layer is thicker than 1.0 nanometer.

46. A micro device, comprising:
a stationary first component on a substrate, the first component having a first surface;
a moveable second component having a second surface, wherein the second component is configured to move into contact with the first surface; and
a carbon layer on at least one of the first surface and the second surface to reduce stiction between the first component and the second component.

47. The micro device of claim 46, wherein the second component is configured to move in response to a voltage signal.

48. The micro device of claim 46, wherein the carbon layer is thicker than 0.3 nanometer.

49. The micro device of claim 48, wherein the carbon layer is thicker than 1.0 nanometer.

50. The micro device of claim 46, wherein the second component comprises a material selected from the group consisting of titanium, tantalum, tungsten, molybdenum, aluminum, aluminum-silicon alloys, silicon, amorphous silicon, polysilicon, silicide and combinations thereof.
